(19) United States
(12) Patent Application Publication
(10) Pub. No.: US 2017/0302389 A1
(43) Pub. Date: Oct. 19, 2017

(54) WIRELESS COMMUNICATION DEVICE AND ABNORMALITY DETECTION METHOD

(71) Applicant: FUJITSU LIMITED, Kawasaki-shi (JP)

(72) Inventors: HIRO YOSHIDA, Kawasaki (JP); Junya MORITA, Yokohama (JP); Takuro Nishikawa, Yokohama (JP); Takeshi OHBA, Yokosuka (JP); Akifumi Adachi, Kawasaki (JP); Shinichiro Kobayashi, Yokohama (JP); Satoshi Matsubara, Kawasaki (JP); Yasushi Seino, Kawasaki (JP); Kouichi Hayasaka, Sendai (JP); Shunsuke Satou, Sendai (JP)

(73) Assignee: FUJITSU LIMITED, Kawasaki-shi (JP)

(21) Appl. No.: 15/468,426

(22) Filed: Mar. 24, 2017

(30) Foreign Application Priority Data
Apr. 19, 2016 (JP) 2016-083759

(51) Int. Cl. H04B 17/29; H04B 1/04

(52) U.S. Cl. CPC H04B 17/29; H04B 1/0475

(57) ABSTRACT

A wireless communication device includes: a transmitting circuit that is connected to an antenna and includes a power amplifier that amplifies an input signal; a receiving circuit that is connected to the antenna and includes a switch that switches as to whether or not a signal is received; and a processor that executes a process including: acquiring timing information that indicates timing of a guard period when no signal is transmitted or received by the antenna; turning on the power amplifier and turning on the switch in the guard period based on the acquired timing information to input a noise signal of the transmitting circuit that is amplified by the power amplifier to the receiving circuit; measuring electrical power of a signal that is output from the receiving circuit in the guard period; and determining abnormality of the receiving circuit based on the measured electrical power.

### CROSS-REFERENCE TO RELATED APPLICATION

This application is based upon and claims the benefit of priority of the prior Japanese Patent Application No. 2016-083759, filed on Apr. 19, 2016, the entire contents of which are incorporated herein by reference.

### FIELD

The embodiments discussed herein are related to a wireless communication device and an abnormality detection method.

### BACKGROUND

For example, in a wireless communication system that includes a base station device and a terminal device, it is generally preferable for such a system to operate stably. In order to cause a wireless communication system to operate stably, preventing occurrence of failure, and in a case where failure occurs, detecting such failure quickly and executing restoration, are needed. Therefore, a function of detecting abnormality such as failure or a trouble may be implemented in a wireless communication device such as a base station device or a terminal device.

A wireless communication device is usually mounted with a transmitting circuit and a receiving circuit. Abnormality detection for a transmitting circuit can comparatively readily be realized by, for example, monitoring electrical power of a known transmitting signal. On the other hand, it is difficult to realize abnormality detection for a receiving circuit by simply monitoring electrical power of a received signal. That is because electrical power of a received signal varies with surrounding environment of a wireless communication device, the number of communication partners, or the like, and hence, it is difficult to uniformly set a criterion as to whether or not abnormality is caused.

Accordingly, for example, a method that inputs a known signal to a receiving circuit and monitors electrical power of such a known signal, or the like, has been known in order to detect abnormality in such a receiving circuit. Specifically, for example, a pilot signal for abnormality detection is input into a receiving circuit and electrical power of a signal that is output from the receiving circuit is monitored. Then, in a case where the electrical power of a signal that is output from the receiving circuit is less than a predetermined threshold, it is determined that abnormality is present in the receiving circuit.

In a case where a predetermined pilot signal is thus used as a known signal, a pilot signal source and a circuit for detection of a pilot signal are added to a wireless communication device, and hence, a circuit size and cost are increased. Furthermore, a pilot signal may be transmitted to an antenna to provide unwanted radiation. Hence, a study has also been executed in such a manner that external noise that is input from an antenna is utilized as a known signal or internal thermal noise of a receiving circuit is utilized.

Japanese Laid-open Patent Publication No. 2015-139156

Japanese Laid-open Patent Publication No. 2010-062624

Japanese Laid-open Patent Publication No. 2006-203550

Meanwhile, a wireless communication device that operates according to, for example, a Time Division Duplex (TDD) method includes an antenna that is commonly used for transmitting and receiving of a signal. Hence, in such a wireless communication device, a transmitting signal that has been amplified by a Power Amplifier (PA) of a transmitting circuit may be reflected from an antenna end and transmitted to a receiving circuit. Electrical power of a signal that is transmitted to a receiving circuit is greater than electrical power of a normal received signal, and hence, as a signal that has been transmitted to the receiving circuit is directly input to the receiving circuit, the receiving circuit may be damaged. Hence, a protection switch that connects an antenna and a receiving circuit at a time of receiving of a signal and terminates connection between the antenna and the receiving circuit at a time of transmitting of a signal may be provided between the antenna and the receiving circuit.

However, in a case where a protection switch that protects a receiving circuit is provided, a problem is that it is difficult to detect abnormality of a receiving circuit accurately as a noise signal such as external noise or internal thermal noise is used as a known signal for abnormality detection. That is, a problem is that no abnormality may be detected in spite of abnormality that is caused in a receiving circuit or a protection switch.

Specifically, for example, a case is considered where a protection switch has been locked in a state where a receiving circuit is connected to an antenna. In such a case, a receiving circuit is also connected to an antenna at a time of transmitting of a signal, and hence, a transmitting signal with large electrical power that has been amplified by a PA is transmitted to the receiving circuit to damage, for example, a Low Noise Amplifier (LNA) provided in the receiving circuit, or the like. As a result, a known signal for abnormality detection is not normally amplified, and hence, it is possible to detect abnormality of a receiving circuit.

On the other hand, for example, a case is considered where a protection switch has been locked in a state where connection between an antenna and a receiving circuit is terminated. In such a case, an LNA or the like that is arranged in a subsequent stage of a protection switch of a receiving circuit continues to operate normally. Hence, in a case where a noise signal is used as a known signal for abnormality detection, electrical power equivalent to a case where a protection switch does not have a trouble is measured due to thermal noise that is generated from a circuit in a subsequent stage thereof or the like, in spite of the protection switch that has a trouble. As a result, it is determined that abnormality is not caused in a receiving circuit.

### SUMMARY

According to an aspect of an embodiment, a wireless communication device includes: a transmitting circuit that is connected to an antenna and includes a power amplifier that amplifies an input signal; a receiving circuit that is connected to the antenna and includes a switch that switches as to whether or not a signal is received; and a processor that executes a process including: acquiring timing information that indicates timing of a guard period when no signal is transmitted or received by the antenna; turning on the power amplifier and turning on the switch in the guard period based on the acquired timing information to input a noise signal of the transmitting circuit that is amplified by the power amplifier to the receiving circuit; measuring electrical power of a signal that is output from the receiving circuit in the guard period; and determining abnormality of the receiving circuit based on the measured electrical power.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a wireless communication device according to a first embodiment;

FIG. 2 is a block diagram illustrating a function of a processor according to the first embodiment;

FIG. 3 is a diagram illustrating a PA and switching control for a protection switch according to the first embodiment;

FIG. 4 is a flow diagram illustrating an abnormality detection process according to the first embodiment;

FIG. 5 is a diagram illustrating a specific example of a result of electrical power measurement in a case where abnormality is absent;

FIG. 6 is a diagram illustrating a specific example of a result of electrical power measurement in a case where abnormality is present;

FIG. 7 is a block diagram illustrating a function of a processor according to a second embodiment;

FIG. 8 is a diagram illustrating a PA and switching control for a protection switch according to the second embodiment;

FIG. 9 is a flow diagram illustrating an abnormality detection process according to the second embodiment;

FIG. 10 is a diagram illustrating a specific example of a result of electrical power measurement;

FIG. 11 is a block diagram illustrating a configuration of a wireless communication device according to a third embodiment;

FIG. 12 is a diagram illustrating a characteristic of a variable capacitance diode;

FIG. 13 is a block diagram illustrating a function of a processor according to the third embodiment; and

FIG. 14 is a flow diagram illustrating an abnormality detection process according to the third embodiment.

### DESCRIPTION OF EMBODIMENTS

Preferred embodiments of the present invention will be explained with reference to accompanying drawings. Herein, the present invention is not limited to these embodiments.

### [a] First Embodiment

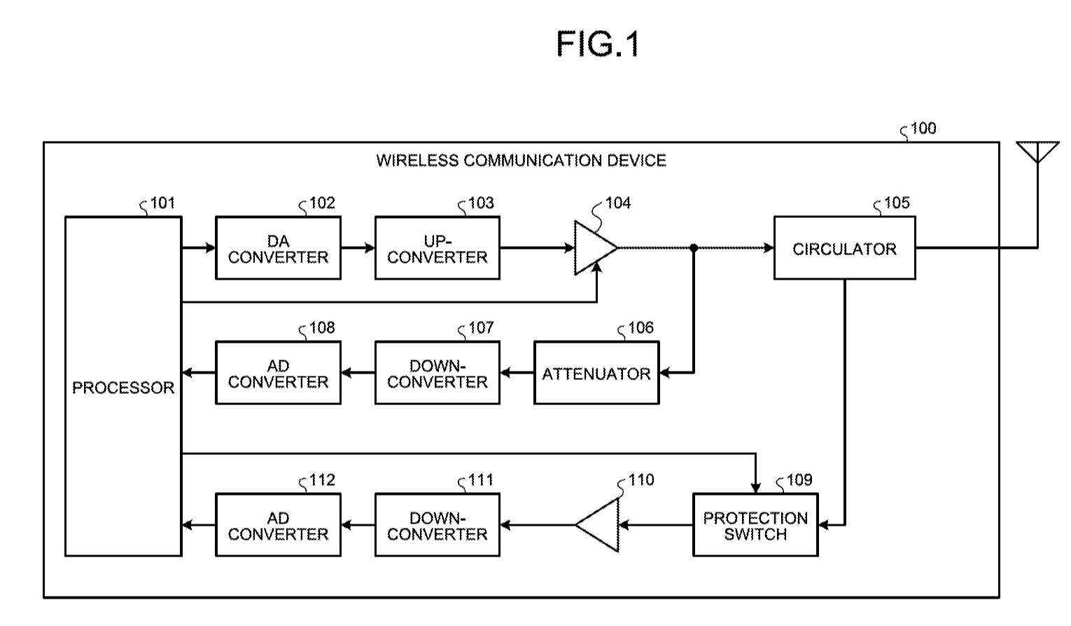

FIG. 1 is a block diagram that illustrates a configuration of a wireless communication device 100 according to a first embodiment. The wireless communication device 100 as illustrated in FIG. 1 includes a processor 101, a Digital Analog (DA) converter 102, an up-converter 103, a power amplifier (PA) 104, a circulator 105, an attenuator 106, a down-converter 107, and an Analog Digital (AD) converter 108. The wireless communication device 100 also includes a protection switch 109, a low noise amplifier (LNA) 110, a down-converter 111, and an AD converter 112. The DA converter 102, the up-converter 103, and the PA 104 compose a transmitting circuit and the protection switch 109, the LNA 110, the down-converter 111, and the AD converter 112 compose a receiving circuit. The attenuator 106, the down-converter 107, and the AD converter 108 compose a feedback circuit.

The processor 101 includes, for example, a Central Processing Unit (CPU), a Field Programmable Gate Array (FPGA), or a Digital Signal Processor (DSP), and overall controls the whole of the wireless communication device 100. That is, the processor 101 executes encoding and modulation of transmitting data to generate a transmitting signal or executes demodulation and decoding of a received signal to acquire receiving data. Furthermore, the processor 101 acquires timing of transmitting and receiving of a signal that is executed by the wireless communication device 100, based on allocation of an up-link and a down-link according to a TDD method that is adopted in a wireless communication system, and executes switching control of the PA 104 and the protection switch 109 depending on the timing thereof. Moreover, the processor 101 measures electrical power of a signal that is output from a receiving circuit, and determines whether or not abnormality is caused in the receiving circuit. A function of the processor 101 will be described in detail later.

The DA converter 102 DA-converts a transmitting signal that is output from the processor 101 and outputs an obtained analog signal to the up-converter 103.

The up-converter 103 up-converts an analog signal that is output from the DA converter 102 into that of a radio frequency, and outputs an obtained radio signal to the PA 104.

The PA 104 is in an on-state at timing of transmitting of a signal according to switching control that is executed by the processor 101, so that a radio signal that is output from the up-converter 103 is amplified. The PA 104 is also in an on-state according to switching control that is executed by the processor 101, even at an interval of Guard Period (GP) where a signal is not transmitted or received, so that a noise signal such as thermal noise that is caused in a transmitting circuit is amplified.

The circulator 105 transmits, through an antenna, a radio signal that is output from the PA 104, and on the other hand, outputs a received signal that is received from the antenna, to the protection switch 109. That is, the circulator 105 separates a transmitting signal and a received signal. However, the circulator 105 also outputs a transmitting signal that is reflected from an antenna end, to the protection switch 109, and hence, does not completely separate a transmitting signal and a received signal, so that the transmitting signal is transmitted to a receiving circuit. Hence, as a noise signal that is output from the PA 104 is reflected from an antenna end, at a GP interval where a signal is not transmitted or received, the circulator 105 outputs such a noise signal to the protection switch 109.

The attenuator 106 provides feedback of a radio signal that is output from the PA 104, and attenuates a feedback signal.

The down-converter 107 down-converts a feedback signal that is fed back by the attenuator 106 into that of a baseband frequency. Then, the down-converter 107 outputs a down-converted feedback signal to the AD converter 108.

The AD converter 108 AD-converts a feedback signal that is output from the down-converter 107, and outputs an obtained digital feedback signal to the processor 101. Such a feedback signal is used for distortion compensation according to a pre-distortion method, by the processor 101.

The protection switch 109 is in an off-state at timing of transmitting of a signal according to switching control that is executed by the processor 101, so that connection between a set of an antenna and the circulator 105 and a receiving circuit is terminated to protect the receiving circuit. That is, the protection switch 109 is in an off-state at timing of transmitting of a signal, so that damage of a receiving circuit that is caused by transmitting of a transmitting signal with large electrical power is prevented. Furthermore, the protection switch 109 is in an on-state at timing of receiving of a signal according to switching control that is executed by the processor 101, so that a received signal that is output from the circulator 105 is output to the LNA 110. Moreover, the protection switch 109 is in an on-state even at a GP interval where a signal is not transmitted or received, according to switching control that is executed by the processor 101, so that a noise signal that is output from the circulator 105 is output to the LNA 110.

The LNA 110 amplifies, with low noise, a received signal or a noise signal that is output from the protection switch 109. Then, the LNA 110 outputs an amplified received signal or noise signal to the down-converter 111.

The down-converter 111 down-converts a received signal or a noise signal that is output from the LNA 110 into that of a baseband frequency. Then, the down-converter 111 outputs a down-converted received signal or noise signal to the AD converter 112.

The AD converter 112 AD-converts a received signal or a noise signal that is output from the down-converter 111, and outputs an obtained digital received signal or noise signal to the processor 101.

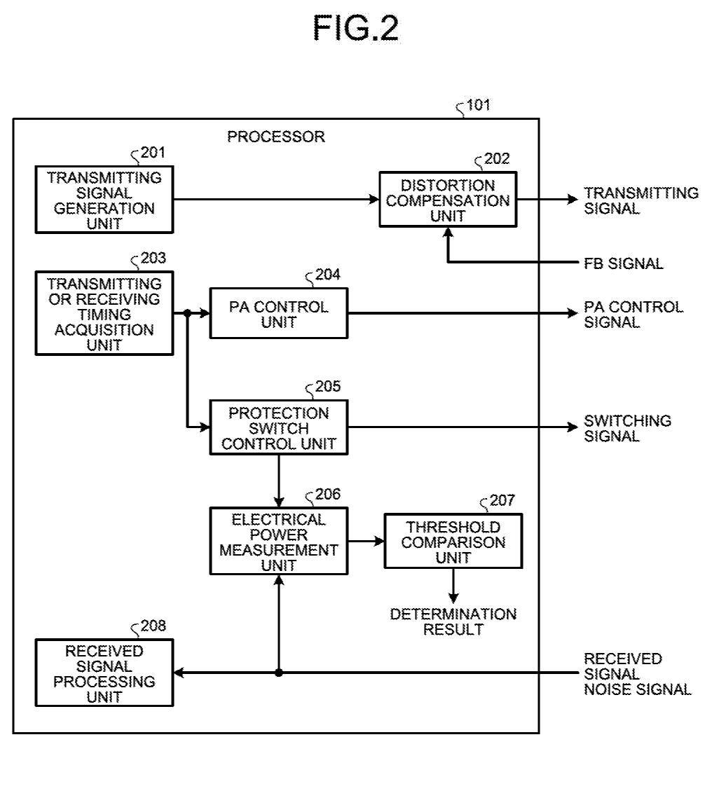

FIG. 2 is a block diagram illustrating a function of the processor 101 according to the first embodiment. The processor 101 as illustrated in FIG. 2 includes a transmitting signal generation unit 201, a distortion compensation unit 202, a transmitting or receiving timing acquisition unit 203, a PA control unit 204, a protection switch control unit 205, an electrical power measurement unit 206, a threshold comparison unit 207, and a received signal processing unit 208.

The transmitting signal generation unit 201 encodes and modulates transmitting data to generate a transmitting signal. Then, the transmitting signal generation unit 201 outputs a generated transmitting signal to the distortion compensation unit 202.

The distortion compensation unit 202 executes compensation of nonlinear distortion that is caused in the PA 104, based on a feedback signal that is amplified by the PA 104 and subsequently fed back (that will be abbreviated as an “FB signal” in FIG. 2). That is, the distortion compensation unit 202 executes distortion compensation according to a pre-distortion method that adds, to a transmitting signal, distortion with a characteristic opposite to that of nonlinear distortion that is caused in the PA 104.

The transmitting or receiving timing acquisition unit 203 acquires information of timing of transmitting and timing of receiving that are defined in a wireless communication system. Specifically, the transmitting or receiving timing acquisition unit 203 acquires sub-frame information that indicates which of a sub-frame for an up-link, a sub-frame for a down-link, and a special sub-frame for a boundary where switching from a down-link to an up-link is executed, each of a plurality of sub-frames that compose one frame corresponds to. Then, the transmitting or receiving timing acquisition unit 203 acquires timing when the wireless communication device 100 transmits a signal, timing when a signal is received thereby, and timing when a signal is not transmitted or received thereby, based on the sub-frame information.

In a case where the wireless communication device 100 is a base station device, the wireless communication device 100 transmits a signal in a sub-frame for a down-link and receives a signal in a sub-frame for an up-link. A GP interval where a signal is not transmitted or received is included in a special sub-frame. A GP interval is arranged at a boundary where switching from a down-link to an up-link is executed, and thereby, interference of down-link and up-link signals can be prevented.

The PA control unit 204 generates a PA control signal that controls an on-state or an off-state of the PA 104 based on timing of transmitting or receiving of a signal that is acquired by the transmitting or receiving timing acquisition unit 203, so as to control the PA 104. Specifically, the PA control unit 204 turns on the PA 104 at timing of transmitting of a signal or timing of a GP interval, or turns off the PA 104 at timing of receiving of a signal. Therefore, the PA control unit 204 generates a PA control signal that turns on the PA 104 to turn on the PA 104 at a time when switching from timing of receiving of a signal to timing of transmitting of a signal or a GP interval is executed, or generates a PA control signal that turns off the PA 104 to turn off the PA 104 at a time when switching from timing of transmitting of a signal or a GP interval to timing of receiving of a signal is executed.

The protection switch control unit 205 generates a switching signal that switches the protection switch 109 on and off based on timing of transmitting or receiving of a signal that has been acquired by the transmitting or receiving timing acquisition unit 203, to control the protection switch 109. Specifically, the protection switch control unit 205 turns on the protection switch 109 at timing of receiving of a signal or a GP interval, to connect a receiving circuit to the circulator 105. On the other hand, the protection switch control unit 205 turns off the protection switch 109 at timing of transmitting of a signal, to terminate connection between the circulator 105 and a receiving circuit. Therefore, the protection switch control unit 205 turns on the protection switch 109 to input a received signal to a receiving circuit at timing of receiving of a signal, or turns off the protection switch 109 to input a noise signal that has been amplified by the PA 104 to the receiving circuit at a GP interval. Furthermore, the protection switch control unit 205 turns off the protection switch 109 not to transmit a transmitting signal with large electrical power that has been amplified by the PA 104 to a receiving circuit at timing of transmitting of a signal.

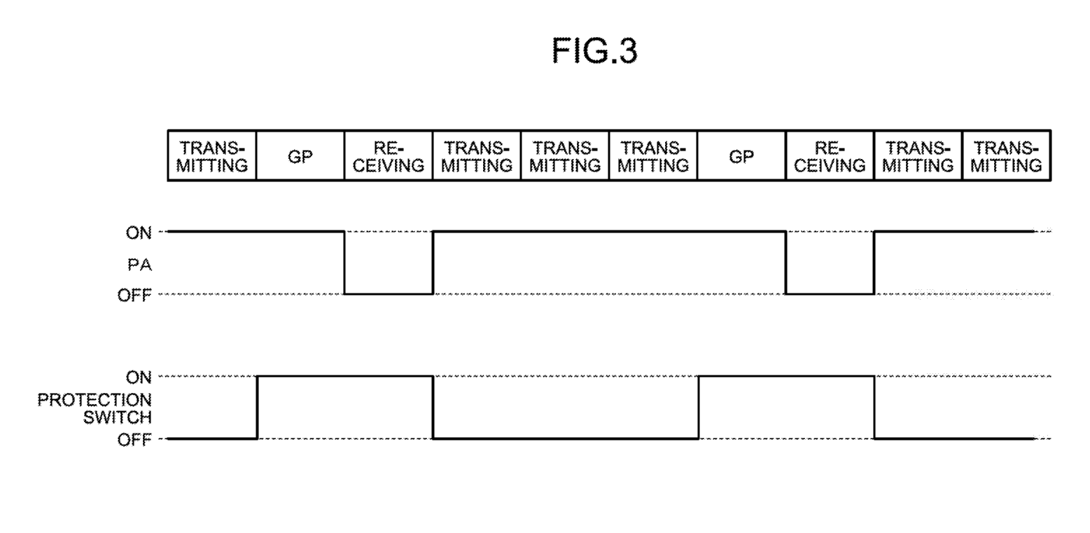

Herein, switching the PA 104 and the protection switch 109 on and off will be described by providing a specific example thereof, with reference to FIG. 3.

An uppermost line in FIG. 3 illustrates an example of timing of transmitting and receiving that is acquired by the transmitting or receiving timing acquisition unit 203. As illustrated in such a figure, in a wireless communication system that adopts a TDD method, timing of transmitting and receiving of a signal is set that repeats, for example, a set of a transmitting interval, a GP interval, a receiving interval, a transmitting interval, and a transmitting interval. Each of such transmitting intervals, a GP interval, and a receiving interval corresponds to, for example, a sub-frame, and one frame is composed of a set of two sub-frames.

The PA control unit 204 generates a PA control signal that turns off the PA 104 at a time when switching from a GP interval to a receiving interval is executed, to switch off the PA 104. Then, the PA control unit 204 generates a PA control signal that turns on the PA 104 at a time when switching from a receiving interval to a transmitting interval is executed, to switch on the PA 104. Thereby, the PA 104 amplifies a transmitting signal at timing of transmitting and amplifies a noise signal such as thermal noise that is caused in a transmitting circuit at a GP interval.

Furthermore, the protection switch control unit 205 generates a switching signal that turns on the protection switch 109 at a time when switching from a transmitting interval to a GP interval is executed, to switch on the protection switch 109. Then, the protection switch control unit 205 generates a switching signal that turns off the protection switch 109 at a time when switching from a receiving interval to a transmitting interval is executed, to switch off the protection switch 109. Thereby, the protection switch 109 inputs an amplified noise signal to a receiving circuit at a GP interval and inputs a received signal to the receiving circuit at timing of receiving. The protection switch 109 protects a receiving circuit at timing of transmitting in such a manner that a transmitting signal is not input to the receiving circuit.

By returning to FIG. 2, the electrical power measurement unit 206 measures electrical power of a signal that is input from a receiving circuit to the processor 101, depending on a switching state of the protection switch 109 that is caused by the protection switch control unit 205. Specifically, the electrical power measurement unit 206 measures electrical power of an output signal from a receiving circuit in a case where the protection switch 109 is turned on at a GP interval. Therefore, the electrical power measurement unit 206 measures electrical power of a noise signal that has been amplified by the PA 104 in a case where abnormality is not caused in a receiving circuit that is the protection switch 109 to the AD converter 112.

The threshold comparison unit 207 compares electrical power that has been measured by the electrical power measurement unit 206 with a predetermined threshold, and outputs a result of determination as to whether or not abnormality is caused in a receiving circuit, depending on a result of comparison. That is, the threshold comparison unit 207 outputs a result of determination that abnormality is absent in a case where measured electrical power is greater than or equal to a predetermined threshold, or outputs a result of determination that abnormality is present, in a case where measured electrical power is less than the predetermined threshold.

The received signal processing unit 208 executes a receiving process such as demodulation and decoding for a received signal that is input from a receiving circuit to the processor 101, to obtain receiving data.

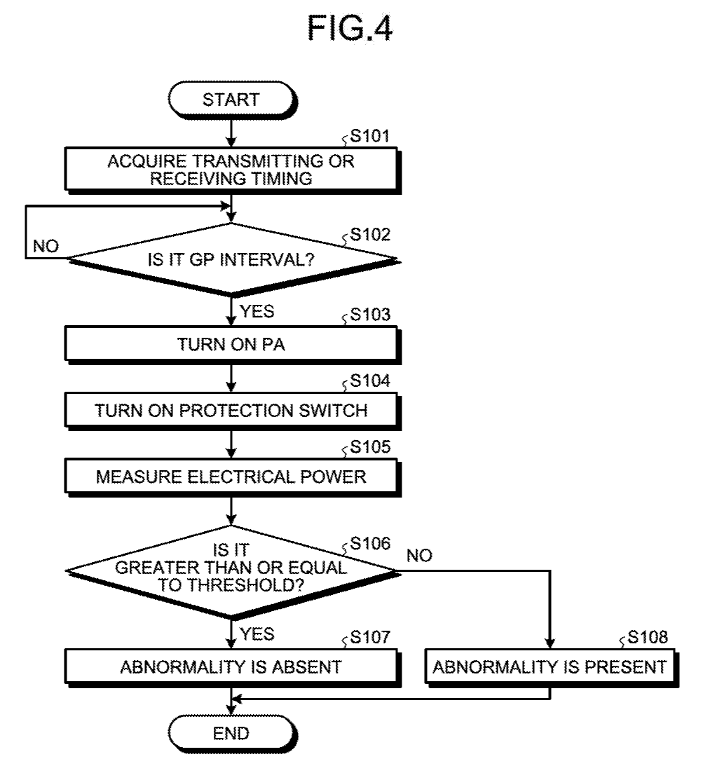

Next, an abnormality detection process of a receiving circuit according to the wireless communication device 100 configured as described above will be described with reference to a flow diagram as illustrated in FIG. 4. The following abnormality detection process is mainly executed by the processor 101.

First, timing of transmitting or receiving according to a TDD method is acquired by the transmitting or receiving timing acquisition unit 203 (step S101). That is, timing of transmitting of the wireless communication device 100, timing of receiving thereof, and timing of a GP interval where transmitting or receiving is not executed are acquired from sub-frame information that indicates, for example, arrangement of a sub-frame for an up-link, a sub-frame for a down-frame, and a special sub-frame. An abnormality detection process of a receiving circuit is executed at timing of a GP interval among timing that has been acquired by the transmitting or receiving timing acquisition unit 203.

Herein, a GP interval is waited (step S102), and as a GP interval comes (step S102, Yes), a PA control signal that turns on the PA 104 is generated by the PA control unit 204 to turn on the PA 104 (step S103). Furthermore, a switching signal that turns on the protection switch 109 is generated by the protection switch control unit 205 to turn on the protection switch 109 (step S104). In a case where the PA 104 or the protection switch 109 has already been turned on at a time when a GP interval has come, a PA control signal or a switching signal is not generated and the PA 104 or the protection switch 109 remains turned on continuously. In short, both the PA 104 and the protection switch 109 are in on-states at a GP interval.

The PA 104 is turned on, and thereby, a noise signal such as thermal noise in a transmitting circuit is amplified by the PA 104 at a GP interval. Furthermore, the protection switch 109 is turned on, and thereby, a noise signal that has been amplified by the PA 104 is input to a receiving circuit at a GP interval. A noise signal that is input to a receiving circuit has been amplified by the PA 104, and hence, has electrical power greater than that of a noise signal such as thermal noise that is caused in a receiving circuit. On the other hand, a noise signal that is input to a receiving circuit is thermal noise or the like in a transmitting circuit that has been amplified by the PA 104, and hence, has sufficiently small electrical power, as compared with a transmitting signal.

A noise signal that has been input to a receiving circuit is amplified by the LNA 110, down-converted by the down-converter 111, and AD-converted by the AD converter 112 to be output to the processor 101. Then, electrical power of an output signal from a receiving circuit is measured by the electrical power measurement unit 206 (step S105). The threshold comparison unit 207 is informed of electrical power that has been measured by the electrical power measurement unit 206, and measured electrical power is compared with a predetermined threshold by the threshold comparison unit 207 (step S106).

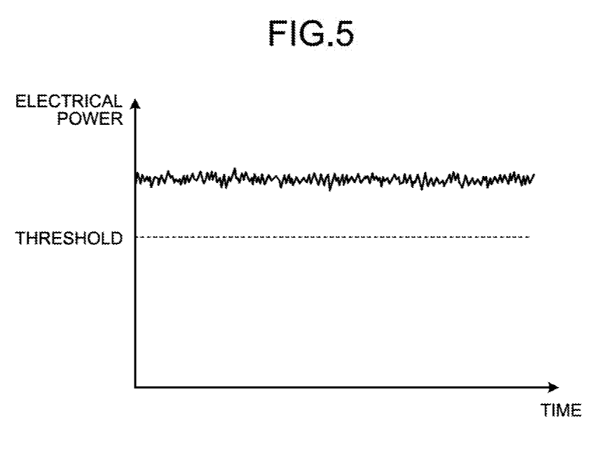

As a result of such comparison, in a case where measured electrical power is greater than or equal to a predetermined threshold (step S106, Yes), a result of determination indicating that abnormality is absent in a receiving circuit is output (step S107). That is, in a case where abnormality is not caused in a receiving circuit, a noise signal that has been amplified by the PA 104 is further amplified by the LNA 110, and hence, electrical power measured by the electrical power measurement unit 206 is greater than electrical power of thermal noise or the like that is caused in the receiving circuit and is greater than or equal to a predetermined threshold. Hence, in a case where electrical power measured by the electrical power measurement unit 206 is greater than or equal to a predetermined threshold, for example, as illustrated in FIG. 5, a result of determination that abnormality is absent is output by the threshold comparison unit 207.

On the other hand, in a case where measured electrical power is less than a predetermined threshold as a result of comparison at step S106 (step S106, No), a result of determination indicating that abnormality is present in a receiving circuit is output (step S108). That is, in a case where, for example, the protection switch 109 or the LNA 110 has a trouble, a noise signal that has been amplified by the PA 104 does not normally pass through a receiving circuit, and hence, electrical power measured by the electrical power measurement unit 206 is less than a predetermined threshold.

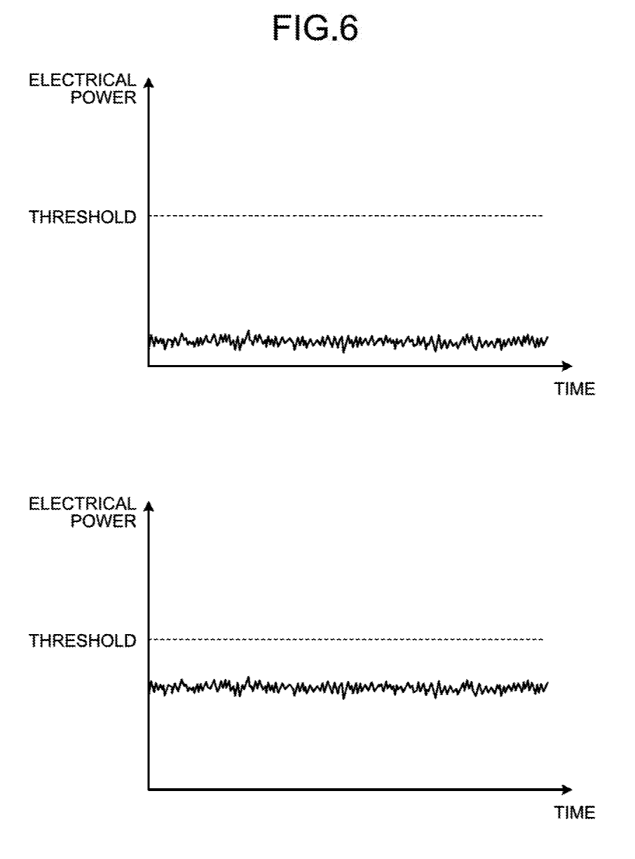

Specifically, in a case where a trouble is caused in, for example, the LNA 110, a noise signal that has been amplified by the PA 104 is not amplified by the LNA 110 and thermal noise or the like that is caused in a receiving circuit is also not amplified. As a result, electrical power measured by the electrical power measurement unit 206 is very small and is less than a predetermined threshold, for example, as illustrated in an upper view of FIG. 6. Hence, a result of determination that abnormality is present is output by the threshold comparison unit 207. Also in a case where the protection switch 109 has a trouble and is locked in an on-state, a transmitting signal with large electrical power that exceeds a dynamic range of the LNA 110 is input to a receiving circuit, and as a result, the LNA has a trouble, so that measured electrical power is less than a predetermined threshold as illustrated in an upper view of FIG. 6.

In a case where, for example, the protection switch 109 has a trouble and is locked in an off-state, a noise signal that has been amplified by the PA 104 is not input to a receiving circuit. Hence, the electrical power measurement unit 206 measures electrical power of a noise signal such as thermal noise that is caused in a receiving circuit. As long as the protection switch 109 is locked in an off-state, a transmitting signal with large electrical power is not input to a receiving circuit, so that the LNA 110 operates normally and a noise signal that has been caused in the receiving circuit is amplified by the LNA 110. However, such a noise signal has not been amplified by the PA 104, and hence, does not have sufficiently large electrical power that is greater than or equal to a predetermined threshold. Therefore, for example, as illustrated in a lower view of FIG. 6, electrical power measured by the electrical power measurement unit 206 is greater than that of a case where the LNA 110 does not operate, and is less than a predetermined threshold. Hence, a result of determination that abnormality is present is output by the threshold comparison unit 207.

As described above, according to the present embodiment, a PA and a protection switch are turned on at a GP interval where transmitting or receiving of a signal is not executed, and a noise signal that has been caused in a transmitting signal is amplified by a PA and input to a receiving circuit. Then, electrical power of an output signal from a receiving circuit is measured and compared with a predetermined threshold, and thereby, whether or not abnormality is caused in the receiving circuit is determined. Hence, whether or not a noise signal that has been caused in a transmitting circuit and amplified has normally passed through a receiving circuit can be determined from a result of measurement of electrical power, so that abnormality in the receiving circuit can be detected accurately.

### [b] Second Embodiment

A feature of a second embodiment is that whether or not abnormality is caused in a receiving circuit can be determined by comparing difference between measured electrical power in an on-state of a protection switch and measured electrical power in an off-state of the protection switch with a predetermined threshold.

A configuration of a wireless communication device according to the second embodiment is similar to that of the first embodiment (FIG. 1), and hence, descriptions thereof will be omitted. A function of a processor 101 in the second embodiment is different from that of the first embodiment.

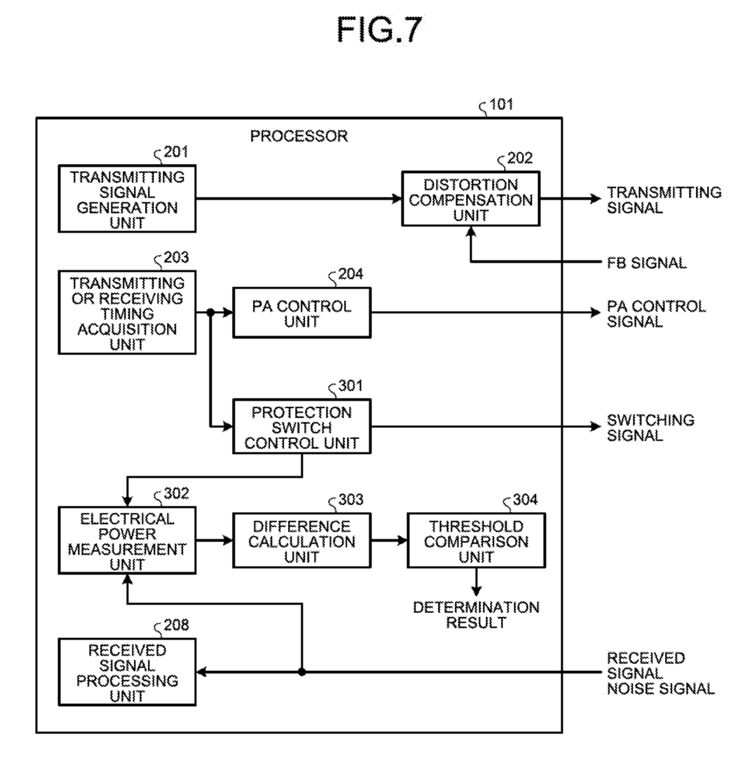

FIG. 7 is a block diagram illustrating a function of the processor 101 according to the second embodiment. A part in FIG. 7 that is identical to that of FIG. 2 is provided with an identical symbol, and descriptions thereof will be omitted. The processor 101 as illustrated in FIG. 7 includes a protection switch control unit 301, an electrical power measurement unit 302, a difference calculation unit 303, and a threshold comparison unit 304, instead of the protection switch control unit 205, the electrical power measurement unit 206, and the threshold comparison unit 207 of the processor 101 as illustrated in FIG. 2.

The protection switch control unit 301 generates a switching signal that switches the protection switch 109 on and off based on timing of transmitting or receiving of a signal that has been acquired by the transmitting or receiving timing acquisition unit 203, to control the protection switch 109. Specifically, the protection switch control unit 301 turns on the protection switch 109 at timing of receiving of a signal to connect a receiving circuit to the circulator 105. On the other hand, the protection switch control unit 301 turns off the protection switch 109 at timing of transmitting of a signal, to terminate connection between the circulator 105 and a receiving circuit.

Furthermore, the protection switch control unit 301 turns on the protection switch 109 at timing of one GP interval, and subsequently, turns off the protection switch 109 at timing of a next GP interval. That is, the protection switch control unit 301 switches on or off the protection switch 109 at each GP interval for abnormality detection for a receiving circuit. Therefore, a noise signal that has been amplified by the PA 104 is input to a receiving circuit at a GP interval where the protection switch 109 is turned on, while the noise signal that has been amplified by the PA 104 is not input to the receiving circuit at a GP interval where the protection switch 109 is turned off.

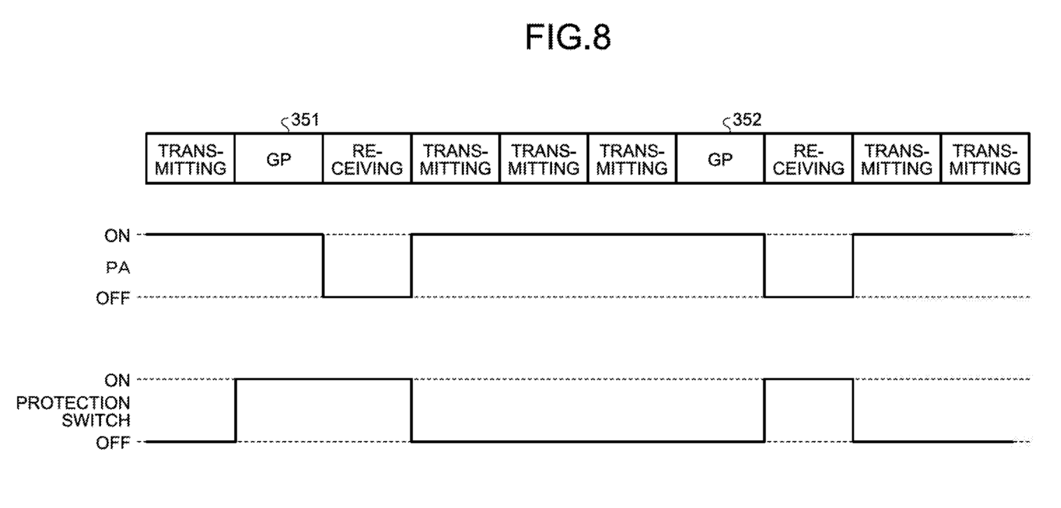

Herein, switching the PA 104 or the protection switch 109 on and off will be described by providing a specific example thereof, with reference to FIG. 8.

An uppermost line in FIG. 8 illustrates an example of timing of transmitting and receiving that is acquired by the transmitting or receiving timing acquisition unit 203. As illustrated in such a figure, in a wireless communication system that adopts a TDD method, timing of transmitting and receiving of a signal is set that repeats, for example, a set of a transmitting interval, a GP interval, a receiving interval, a transmitting interval, and a transmitting interval. GP intervals 351 and 352 are provided in respective spaces between a transmitting interval and a receiving interval.

The PA control unit 204 generates a PA control signal that turns off the PA 104 at a time when switching from the GP interval 351 or 352 to a receiving interval is executed, to switch off the PA 104. Then, the PA control unit 204 generates a PA control signal that turns on the PA 104 at a time when switching from a receiving interval to a transmitting interval is executed, to switch on the PA 104. Thereby, the PA 104 amplifies a transmitting signal at timing of transmitting and amplifies a noise signal such as thermal noise that is caused in a transmitting circuit at the GP interval 351 or 352.

Furthermore, the protection switch control unit 301 generates a switching signal that turns on the protection switch 109 at a time when switching from a transmitting interval to the GP interval 351 is executed, to switch on the protection switch 109. Then, the protection switch control unit 205 generates a switching signal that turns off the protection switch 109 at a time when switching from a receiving interval to a transmitting interval is executed, to switch off the protection switch 109. Moreover, the protection switch control unit 301 causes the protection switch 109 to remain an off-state thereof at the GP interval 352 and generates a switching signal that turns on the protection switch 109 at a time when switching from the GP interval 351 to a receiving interval to is executed, to switch on the protection switch 109. Thereby, the protection switch 109 inputs an amplified noise signal to a receiving circuit at the GP interval 351 while an amplified noise signal is not input to the receiving circuit at the GP interval 352.

By returning to FIG. 7, the electrical power measurement unit 302 measures electrical power of a signal that is input from a receiving circuit to the processor 101, depending on a switching state of the protection switch 109 that is caused by the protection switch control unit 301. Specifically, the electrical power measurement unit 302 measures electrical power of an output signal from a receiving circuit at each of a GP interval where the protection switch 109 is turned on and a GP interval where the protection switch 109 is turned off. Therefore, the electrical power measurement unit 302 measures electrical power of a noise signal that has been amplified by the PA 104 at a GP interval where the protection switch 109 is turned on, in a case where abnormality is not caused in a receiving circuit that is the protection switch 109 to the AD converter 112. Furthermore, the electrical power measurement unit 302 measures electrical power of a noise signal such as thermal noise that has been caused in a receiving circuit, at a GP interval where the protection switch 109 is turned off.

The difference calculation unit 303 calculates difference between measured electrical power at a GP interval where the protection switch 109 is turned on and measured electrical power at a GP interval where the protection switch 109 is turned off. That is, the difference calculation unit 303 calculates electrical power difference of an output signal from a receiving circuit at a time when the protection switch 109 is switched on and off.

The threshold comparison unit 304 compares electrical power difference that has been calculated by the difference calculation unit 303 with a predetermined threshold, and outputs a result of determination as to whether or not abnormality is caused in a receiving circuit, depending on a result of comparison. That is, the threshold comparison unit 304 outputs a result of determination that abnormality is absent in a case where electrical power difference is greater than or equal to a predetermined threshold, or outputs a result of determination that abnormality is present, in a case where electrical power difference is less than the predetermined threshold. A threshold that is compared with electrical power difference by the threshold comparison unit 304 may be, for example, a value that corresponds to isolation of the protection switch 109.

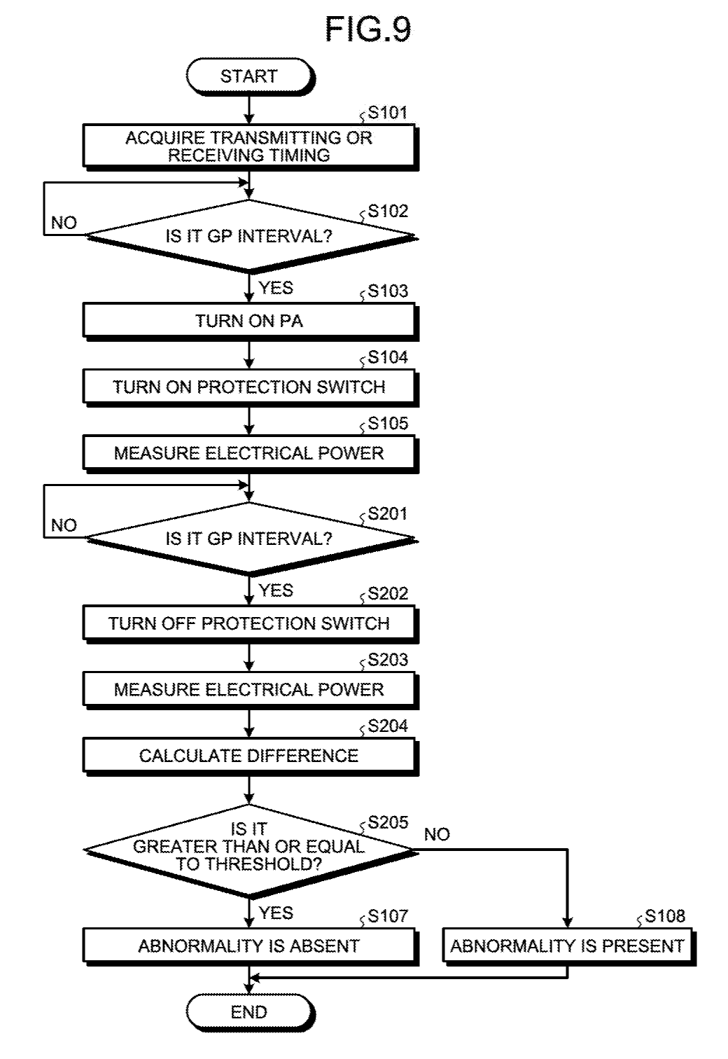

Next, an abnormality detection process of a receiving circuit according to the wireless communication device configured as described above will be described with reference to a flow diagram as illustrated in FIG. 9. A part in FIG. 9 that is identical to that of FIG. 4 is provided with an identical symbol, and detailed descriptions thereof will be omitted. The following abnormality detection process is mainly executed by the processor 101.

First, timing of transmitting or receiving according to a TDD method is acquired by the transmitting or receiving timing acquisition unit 203 (step S101). An abnormality detection process of a receiving circuit is executed at timing of a GP interval among timing that has been acquired by the transmitting or receiving timing acquisition unit 203. Herein, a GP interval is waited (step S102), and as a GP interval comes (step S102, Yes), a PA control signal that turns on the PA 104 is generated by the PA control unit 204 to turn on the PA 104 (step S103). Furthermore, a switching signal that turns on the protection switch 109 is generated by the protection switch control unit 301 to turn on the protection switch 109 (step S104). In a case where the PA 104 or the protection switch 109 has already been turned on at a time when a GP interval has come, a PA control signal or a switching signal is not generated and the PA 104 or the protection switch 109 remains turned on continuously.

The PA 104 is turned on, and thereby, a noise signal such as thermal noise in a transmitting circuit is amplified by the PA 104 at a GP interval. Furthermore, the protection switch 109 is turned on, and thereby, a noise signal that has been amplified by the PA 104 is input to a receiving circuit at this GP interval.

A noise signal that has been input to a receiving circuit is amplified by the LNA 110, down-converted by the down-converter 111, and AD-converted by the AD converter 112 to be output to the processor 101. Then, electrical power of an output signal from a receiving circuit is measured by the electrical power measurement unit 302 (step S105).

After electrical power measurement has been completed at a GP interval where the protection switch 109 is turned on, a next GP interval is waited (step S201), and as such a GP interval comes (step S201, Yes), a switching signal that turns off the protection switch 109 is generated by the protection switch control unit 301 to turn off the protection switch 109 (step S202). In a case where the protection switch 109 has already been turned off at a time when a GP interval has come, a switching signal is not generated and the protection switch 109 remains turned off continuously. On the other hand, the PA 104 is turned on by the PA control unit 204, similarly to the GP interval as described above.

The PA 104 is turned on, and thereby, a noise signal such as thermal noise in a transmitting circuit is amplified by the PA 104 at a GP interval. Furthermore, the protection switch 109 is turned off, and thereby, a noise signal that has been amplified by the PA 104 is not input to a receiving circuit at this GP interval.

Hence, in a state where a noise signal that has been amplified by the PA 104 is not input to a receiving circuit, electric power of an output signal from the receiving circuit is measured by the electrical power measurement unit 302 (step S203). Herein, a noise signal that has been amplified by the PA 104 is not input to a receiving circuit, so that a noise signal such as thermal noise that is caused in the receiving circuit is amplified by the LNA 110, and electrical power of such a noise signal is measured by the electrical power measurement unit 302. At a GP interval where the protection switch 109 is turned off, a noise signal that has been amplified by the PA 104 is not input to a receiving circuit, and hence, electrical power of an output signal from the receiving circuit is small as compared with a GP interval where the protection switch 109 is turned on.

Electrical power measured at each GP interval is output to the difference calculation unit 303, and difference between measured electrical power at a GP interval where the protection switch 109 is turned on and measured electrical power at a GP interval where the protection switch 109 is turned off is calculated by the difference calculation unit 303 (step S204). The threshold comparison unit 304 is informed of calculated difference that is then compared with a predetermined threshold by the threshold comparison unit 304 (step S205).

As a result of such comparison, in a case where electrical power difference is greater than or equal to a predetermined threshold (step S205, Yes), a result of determination indicating that abnormality is absent in a receiving circuit is output (step S107). That is, in a case where abnormality is not caused in a receiving circuit, the protection switch 109 is normally switched on and off at two GP intervals, so that electrical power difference that is calculated by the difference calculation unit 303 is increased.

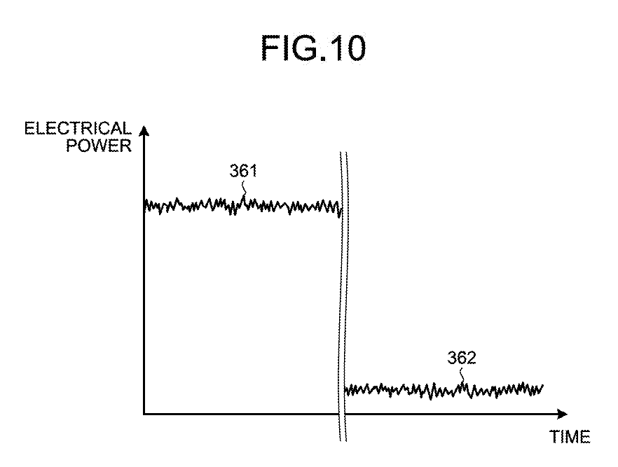

Specifically, a noise signal that has been amplified by the PA 104 is included in an output signal from a receiving circuit at a GP interval where the protection switch 109 is turned on, for example, as illustrated in FIG. 10, and hence, measured electrical power 361 is increased. On the other hand, a noise signal that has been amplified by the PA 104 is not included in an output signal from a receiving circuit at a GP interval where the protection switch 109 is turned off, and hence, measured electrical power 362 is decreased. Furthermore, impedance of an antenna end is changed due to, for example, an environmental condition such as temperature, or the like, and thereby, values of the measured electrical power 361 and 362, per se, can vary. However, difference between the measured electrical power 361 and 362 corresponds to an isolation characteristic of the protection switch 109 and does not greatly vary due to an environmental condition. As a result, in a case where abnormality is not caused in a receiving circuit, electrical power difference that is calculated by the difference calculation unit 303 is greater than or equal to a predetermined threshold. Hence, a result of determination that abnormality is absent is output by the threshold comparison unit 304.

On the other hand, in a case where electrical power difference is less than a predetermined threshold as a result of comparison at step S205 (step S205, No), a result of determination indicating that abnormality is present in a receiving circuit is output (step S108). That is, in a case where, for example, the protection switch 109 or the LNA 110 has a trouble, electrical power of a signal that is output from a receiving circuit is not changed even in a case where the protection switch 109 is switched on and off at two GP intervals, so that electrical power difference that is calculated by the difference calculation unit 303 is decreased. As a result, in a case where abnormality is caused in a receiving circuit, electrical power difference that is calculated by the difference calculation unit 303 is less than a predetermined threshold. Hence, a result of determination that abnormality is present is output by the threshold comparison unit 207.

As described above, according to the present embodiment, electrical power of an output signal from a receiving circuit in a case where a protection switch is switched on and off is measured at a GP interval where transmitting or receiving of a signal is not executed. Then, difference between measured electrical power in a case of an on-state of a protection and a case of an off-state thereof is compared with a predetermined threshold, and thereby, whether or not abnormality is caused in a receiving circuit is determined. Hence, whether or not a protection switch is normally switched on and off can be determined based on a result of electrical power measurement, so that abnormality in a receiving circuit can be detected accurately. Furthermore, measured electrical power difference is compared with a predetermined threshold, and hence, abnormality in a receiving circuit can accurately be detected by excluding influence of an environmental condition, even in a case where electrical power of a signal varies due to the environmental condition or the like.

Although a GP interval where the protection switch 109 is turned on and a GP interval where the protection switch 109 is turned off are provided separately in the second embodiment as described above, an interval where the protection switch 109 is turned on and an interval where it is turned off may be provided in one GP interval. In such a case, electrical power difference of an output signal from a receiving circuit is calculated and compared with a predetermined threshold in one GP interval, and thereby, abnormality in a receiving circuit can be detected.

### [c] Third Embodiment

A feature of a third embodiment is that impedance of an antenna end is kept constant, and thereby, variation of electrical power of a signal that is caused by an environmental condition is reduced.

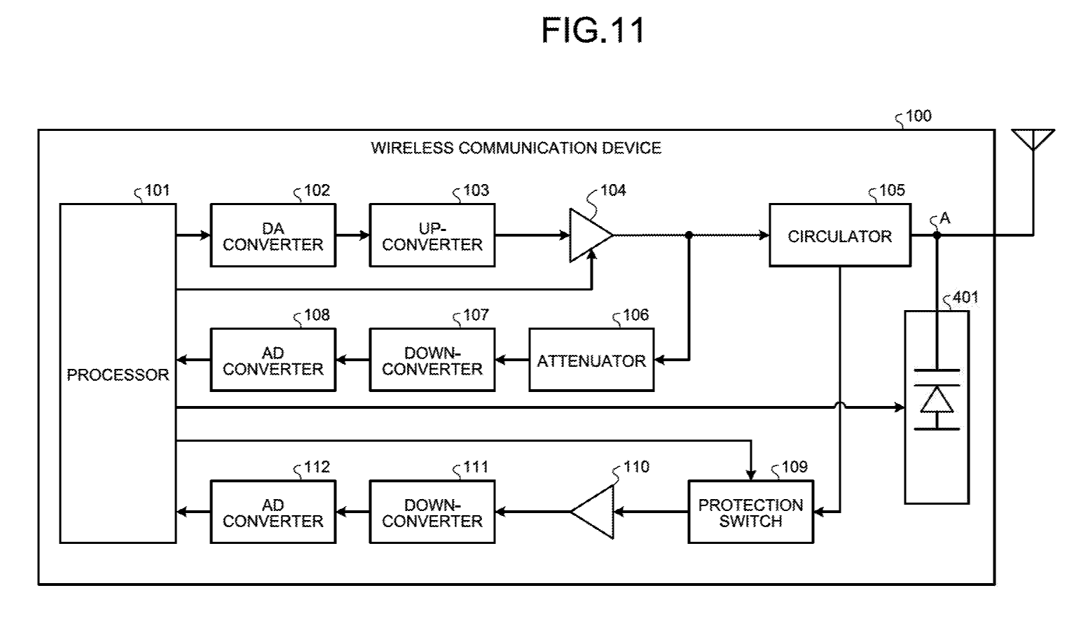

FIG. 11 is a block diagram illustrating a configuration of a wireless communication device 100 according to the third embodiment. A part in FIG. 11 that is identical to that of FIG. 1 is provided with an identical symbol, and descriptions thereof will be omitted. The wireless communication device 100 as illustrated in FIG. 11 is configured in such a manner that a variable impedance circuit 401 is added to the wireless communication device 100 as illustrated in FIG. 1.

The variable impedance circuit 401 changes impedance at point A in FIG. 11. That is, the variable impedance circuit 401 changes impedance at an antenna end at a GP interval according to control from the processor 101 and totally reflects a noise signal that has been amplified by the PA 104.

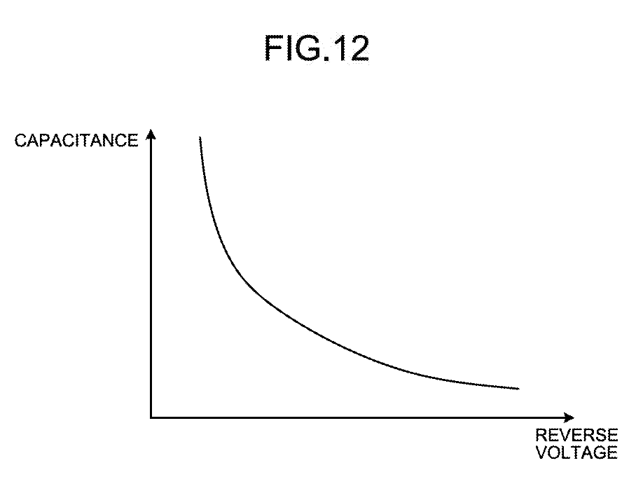

Specifically, the variable impedance circuit 401 includes, for example, a variable-capacitance diode. A variable-capacitance diode has a characteristic in such a manner that a capacitance thereof is reduced as a reverse voltage is applied thereto, for example, as illustrated in FIG. 12. Therefore, a reverse voltage is applied to a variable-capacitance diode at a GP interval to change impedance at the point A in FIG. 11, so that the point A can be on a short-circuit condition. As a result, the variable impedance circuit 401 totally reflects, at the point A, a signal that is output from the circulator 105 to an antenna. A totally reflected signal passes through the circulator 105 again and is output to the protection switch 109. At a GP interval, a noise signal that has been amplified by the PA 104 is output from the circulator 105 to an antenna, and hence, a noise signal that has been amplified by the PA 104 is totally reflected at the point A and output to the protection switch 109.

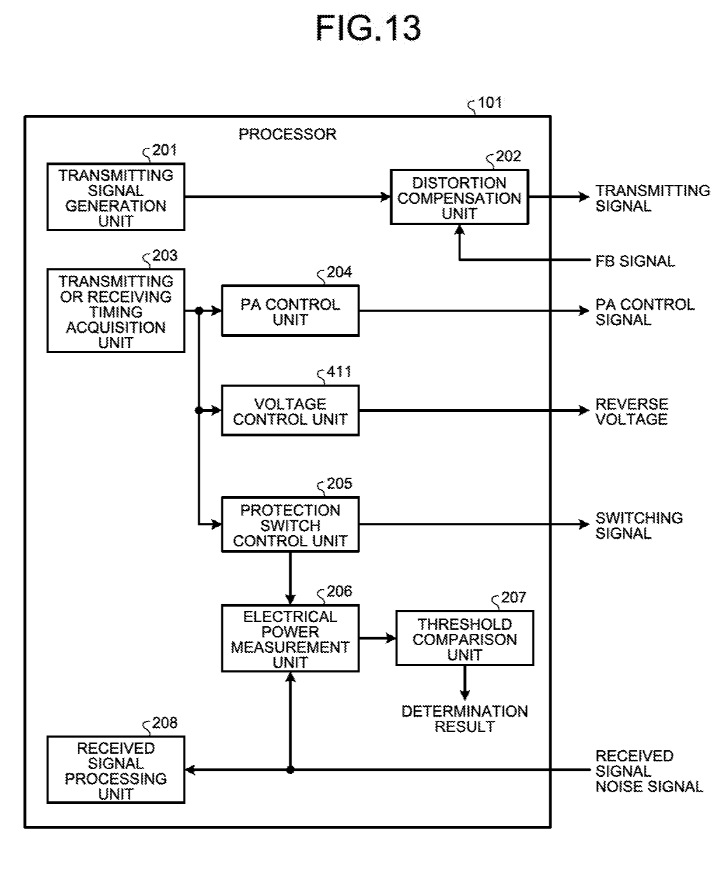

FIG. 13 is a block diagram illustrating a function of a processor 101 according to the third embodiment. A part in FIG. 13 that is identical to that of FIG. 2 is provided with an identical symbol, and descriptions thereof will be omitted. The processor 101 as illustrated in FIG. 13 is configured in such a manner that a voltage control unit 411 is added to the processor 101 as illustrated in FIG. 2.

The voltage control unit 411 applies a reverse voltage to a variable-capacitance diode of the variable impedance circuit 401 based on timing of transmitting or receiving of a signal that is acquired by the transmitting or receiving timing acquisition unit 203. Specifically, the voltage control unit 411 applies a reverse voltage to a variable-capacitance diode at timing of a GP interval to change impedance at the point A in FIG. 11.

Thus, in the present embodiment, the voltage control unit 411 applies a reverse voltage to the variable impedance circuit 401, and thereby, totally reflects a signal at an antenna end at a GP interval. Hence, even in a case where impedance at an antenna end is changed due to, for example, an environmental condition such as temperature, an amount of a reflected signal at the antenna end can be constant. As a result, a noise signal that is amplified by the PA 104 is all output to the protection switch 109 at a GP interval, so that electrical power of a noise signal that is input to a receiving circuit can be prevented from changing due to an environmental condition.

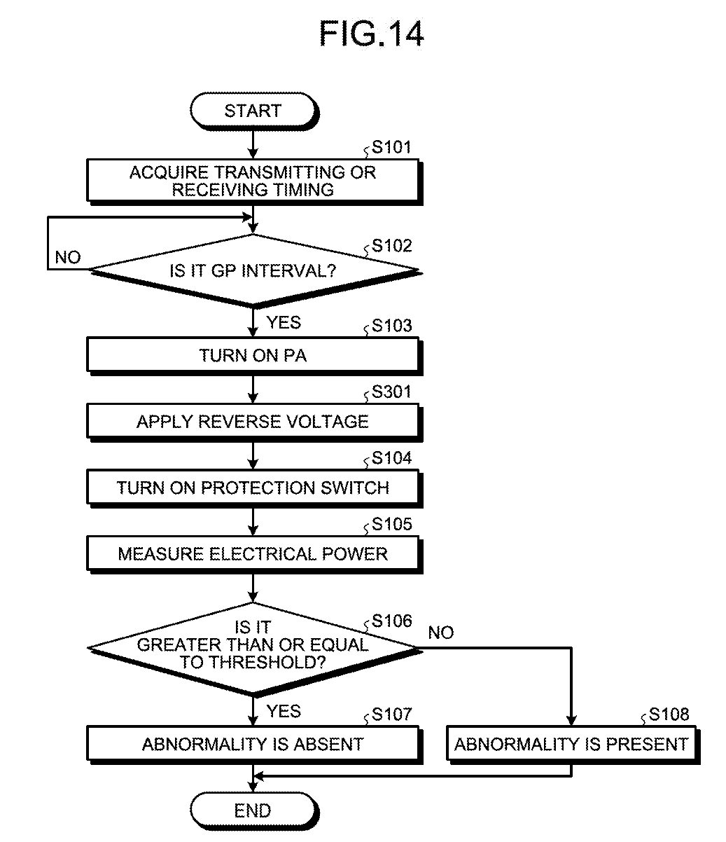

Next, an abnormality detection process of a receiving circuit according to the wireless communication device 100 configured as described above will be described with reference to a flow diagram as illustrated in FIG. 14. A part in FIG. 14 that is identical to that of FIG. 4 is provided with an identical symbol, and detailed descriptions thereof will be omitted. The following abnormality detection process is mainly executed by the processor 101.

First, timing of transmitting or receiving according to a TDD method is acquired by the transmitting or receiving timing acquisition unit 203 (step S101). An abnormality detection process of a receiving circuit is executed at timing of a GP interval among timing that has been acquired by the transmitting or receiving timing acquisition unit 203. Herein, a GP interval is waited (step S102), and as a GP interval comes (step S102, Yes), a PA control signal that turns on the PA 104 is generated by the PA control unit 204 to turn on the PA 104 (step S103). Furthermore, a reverse voltage is applied to a variable-capacitance diode of the variable impedance circuit 401 by the voltage control unit 411 (step S301). Thereby, a signal that is output from the circulator 105 to an antenna is totally reflected at the point A in FIG. 11, passes through the circulator 105 again, and is output to the protection switch 109.

Moreover, a switching signal that turns on the protection switch 109 is generated by the protection switch control unit 205 to turn on the protection switch 109 (step S104). In a case where the PA 104 or the protection switch 109 has already been turned on at a time when a GP interval has come, a PA control signal or a switching signal is not generated and the PA 104 or the protection switch 109 remains turned on continuously.

The PA 104 is turned on, and thereby, a noise signal such as thermal noise in a transmitting circuit is amplified by the PA 104 at a GP interval. A noise signal that has been amplified by a PA is output from the circulator 105 to an antenna, and totally reflected toward the circulator 105 because the point A is on a short-circuit condition due to the variable impedance circuit 401. Then, the protection switch 109 has been turned on at a GP interval, and hence, a noise signal that has been totally reflected at the point A is input to a receiving circuit.

A noise signal that has been input to a receiving circuit is amplified by the LNA 110, down-converted by the down-converter 111, and AD-converted by the AD converter 112 to be output to the processor 101. Then, electrical power of an output signal from a receiving circuit is measured by the electrical power measurement unit 206 (step S105). The threshold comparison unit 207 is informed of electrical power that has been measured by the electrical power measurement unit 206 and measured electrical power is compared with a predetermined threshold by the threshold comparison unit 207 (step S106).

As a result of such comparison, in a case where measured electrical power is greater than or equal to a predetermined threshold (step S106, Yes), a result of determination indicating that abnormality is absent in a receiving circuit is output (step S107). On the other hand, in a case where measured electrical power is less than a predetermined threshold as a result of comparison at step S106 (step S106, No), a result of determination indicating that abnormality is present in a receiving circuit is output (step S108).

As described above, according to the present embodiment, a PA and a protection switch are turned on at a GP interval where transmitting or receiving of a signal is not executed and impedance of an antenna end, so that a noise signal that has been amplified by the PA is totally reflected toward a receiving circuit. Then, electrical power of an output signal from a receiving circuit is measured and compared with a predetermined threshold, and thereby, whether or not abnormality is caused in the receiving circuit is determined. Hence, whether or not a noise signal that is caused in a transmitting circuit and has been amplified has passed a receiving circuit normally can be determined from a result of electrical power measurement, so that abnormality in the receiving circuit can be detected accurately. Furthermore, a signal can be totally reflected by controlling impedance at an antenna end, even in a case where, for example, an environmental condition such as temperature is changed, so that electrical power of a noise signal that is input to a receiving circuit can be prevented from changing due to an environmental condition. As a result, abnormality in a receiving circuit can accurately be detected by excluding influence of an environmental condition.

According to one aspect of a wireless communication device and an abnormality detection method that are disclosed in the present application, an advantageous effect is provided in such a manner that abnormality of a receiving circuit can be detected accurately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device, comprising:
a transmitting circuit that is connected to an antenna and includes a power amplifier that amplifies an input signal;
a receiving circuit that is connected to the antenna and includes a switch that switches as to whether or not a signal is received; and
a processor that executes a process including:
acquiring timing information that indicates timing of a guard period when no signal is transmitted or received by the antenna;
turning on the power amplifier and turning on the switch in the guard period based on the acquired timing information to input a noise signal of the transmitting circuit that is amplified by the power amplifier to the receiving circuit;
measuring electrical power of a signal that is output from the receiving circuit in the guard period; and
determining abnormality of the receiving circuit based on the measured electrical power.

2. The wireless communication device according to claim 1, wherein:
the determining includes comparing the measured electrical power and a predetermined threshold, and in a case where the measured electrical power is greater than or equal to the predetermined threshold, outputting a determination result being that abnormality is absent in the receiving circuit.

3. The wireless communication device according to claim 1, wherein:
the turning on the switch includes providing an interval where the switch is turned on in the guard period and an interval where the switch is turned off therein, and the determining includes calculating difference of the measured electrical power between the interval where the switch is turned on and the interval where the switch is turned off and determining abnormality of the receiving circuit based on the calculated difference.

4. The wireless communication device according to claim 3, wherein:
the determining includes comparing the calculated difference and a predetermined threshold, and in a case where the calculated difference is greater than or equal to a predetermined threshold, outputting a determination result being that abnormality is absent in the receiving circuit.

5. The wireless communication device according to claim 1, further comprising:
a variable impedance circuit that changes impedance between the power amplifier and the antenna, wherein the processor executes the process further including controlling the variable impedance circuit in the guard period to reflect, and input to the receiving circuit, the noise signal of the transmitting circuit that is amplified by the power amplifier.

6. An abnormality detection method for a wireless communication device that includes a transmitting circuit that is connected to an antenna and includes a power amplifier that amplifies an input signal and a receiving circuit that is connected to the antenna and includes a switch that switches as to whether or not a signal is received, the abnormality detection method comprising:
acquiring, by a processor, timing information that indicates timing of a guard period when no signal is transmitted or received by the antenna;
turning on the power amplifier and turning on the switch in the guard period, by the processor, based on the acquired timing information to input a noise signal of the transmitting circuit that is amplified by the power amplifier to the receiving circuit;
measuring, by the processor, electrical power of a signal that is output from the receiving circuit in the guard period; and
determining, by the processor, abnormality of the receiving circuit based on the measured electrical power.
